(19) United States
(12) Patent Application Publication
(10) Pub. No.: US 2025/0344301 A1
(43) Pub. Date: Nov. 6, 2025

(54) LED LAMP WITH MULTI-COLOR TEMPERATURE SWITCHING AND CONTROL METHOD THEREFOR

(71) Applicant: Xiamen Topstar Lighting Co., Ltd., Xiamen (CN)

(72) Inventors: Yongjie WU, Xiamen (CN); Shizhang WU, Xiamen (CN); Yebiao HUANG, Xiamen (CN)

(73) Assignee: Xiamen Topstar Lighting Co., Ltd., Xiamen (CN)

(21) Appl. No.: 19/270,744

(22) Filed: Jul. 16, 2025

(30) Foreign Application Priority Data
May 20, 2025 (CN) 202520991416.8

(51) Int. Cl. H05B 45/20; F21V 23/04; F21Y 115/10; H05B 45/10; H05B 45/325; H05B 45/34; H05B 45/345; H05B 45/3725

(52) U.S. Cl. CPC H05B 45/20; H05B 45/10; H05B 45/325; H05B 45/34; H05B 45/345; H05B 45/3725; F21V 23/04; F21Y 2115/10

(57) ABSTRACT

An LED lamp with multi-color temperature switching includes a control processor, a dip switch processor, a wall switch processor and a dual-color light source unit. By connecting the dip switch processor and the wall switch processor to the control processor, respectively, the control processor adjusts a current output to the dual-color light source unit according to a dip switch signal or a wall switch. This enables the color temperature of the lamp to be directly determined by positioning a dip switch to a corresponding color temperature position, and allows the color temperature to be selected by operating a wall switch, thereby allowing for flexible switching of color temperature.

### CROSS-REFERENCE TO RELATED APPLICATIONS

The present application claims priority to Chinese Patent Application No. 202520991416.8, filed on May 20, 2025. The entire content of the above-mentioned application is incorporated herein by reference.

### TECHNICAL FIELD

The present disclosure relates to the technical field of intelligent lighting, and in particular, to a light emitting diode (LED) lamp with multi-color temperature switching and a control method therefor.

### BACKGROUND

Existing LED lamps often feature a color adjustment function. Currently, conventional color temperature switching solutions are implemented in two ways as follows.

Solution 1: a multi-position dip switch is connected in series into an LED lamp, and resistors with different resistance values are connected in series at different switching positions of the dip switch to change the equivalent impedance of the corresponding color temperature, thereby adjusting the current flowing through light sources with different color temperatures, and eventually altering the color temperature. For example, by changing the currents in white light path and yellow light path of LED, the color temperature is adjusted. However, since the dip switch is often disposed on the lamp itself, the lamp needs to be removed to toggle the switch by manual, and then installed again.

Solution 2: a color temperature switching chip is connected in series onto an LED lamp. Taking three-position color temperature switching as an example, a user can switch among different color temperatures by repeatedly operating a wall switch. However, this solution often results in poor experience because it is easy to toggle the switch too many times or by accident to miss the desired color temperature. Moreover, if more color temperature positions are added, more repeated toggling is required, while practical switchable color temperature positions are limited. The above statements are provided solely as background information related to the present invention, and do not necessarily constitute the prior art.

### SUMMARY

In order to solve the above technical problems, a technical solution employed by the present disclosure is as follows.

An LED lamp with multi-color temperature switching includes: a control processor, where a first input end of the control processor is connected to an output end of a dip switch processor that receives a dip switch signal; a second input end of the control processor is connected to an output end of a wall switch processor that receives a wall switch signal; an output end of the control processor is connected to a control end of a dual-color light source unit; and the control processor adjusts a current output to the dual-color light source unit according to the dip switch signal or the wall switch signal.

In order to solve the above technical problems, another technical solution employed by the present disclosure is as follows.

A control method for an LED lamp with multi-color temperature switching includes: acquiring, upon receiving a power-on signal and detecting a change in position information of a dip switch processor, corresponding color adjustment information according to the position information; further lighting up a light source of a dual-color light source unit according to the color adjustment information; recording, when a wall switch processor triggers a color adjustment mode, target color adjustment information corresponding to a target color temperature; and lighting up the dual-color light source unit according to the target color adjustment information.

### BRIEF DESCRIPTION OF THE DRAWINGS

FIG. 1 is a structural diagram of a circuit of an LED lamp with multi-color temperature switching according to some embodiments of the present disclosure.

FIG. 2 is a schematic diagram of a control processor of an LED lamp with multi-color temperature switching according to some embodiments of the present disclosure.

FIG. 3 is a schematic diagram of a dip switch processor of an LED lamp with multi-color temperature switching according to some embodiments of the present disclosure.

FIG. 4 is a schematic diagram of a wall switch processor of an LED lamp with multi-color temperature switching according to some embodiments of the present disclosure.

FIG. 5 is a schematic diagram of a dimming constant current processor of an LED lamp with multi-color temperature switching according to some embodiments of the present disclosure.

FIG. 6 is a flowchart of steps of an LED lamp with multi-color temperature switching according to some embodiments of the present disclosure.

FIG. 7 is a schematic diagram of a control method for an LED lamp with multi-color temperature switching according to some embodiments of the present disclosure.

FIG. 8 is a schematic structural diagram of an LED lamp with multi-color temperature switching according to some embodiments of the present disclosure.

### DETAILED DESCRIPTION OF THE EMBODIMENTS

In order to illustrate the technical contents, objectives and effects of the present disclosure in detail, the following description is made in conjunction with the implementations and accompanying drawings.

An LED lamp with multi-color temperature switching includes: a control processor, where a first input end of the control processor is connected to an output end of a dip switch processor that receives a dip switch signal, and a second input end of the control processor is connected to an output end of a wall switch processor that receives a wall switch signal; an output end of the control processor is connected to a control end of a dual-color light source unit; and the control processor adjusts a current output to the dual-color light source unit according to the dip switch signal or the wall switch signal.

As can be seen from the above description, the beneficial effects of the present disclosure are as follows: by connecting the dip switch processor and the wall switch processor to the control processor, respectively, the control processor adjusts the current output to the dual-color light source unit according to the dip switch signal or the wall switch signal. This enables the color temperature of the lamp to be directly determined by positioning the dip switch to a corresponding color temperature position, and allows the color temperature to be selected by operating the wall switch, thereby allowing for flexible switching of the color temperature.

Further, the control processor includes a control unit and a dual-color channel unit, where a first input end of the control unit is connected to the output end of the dip switch processor; a second input end of the control unit is connected to the output end of the wall switch processor; an output end of the control unit is connected to an input end of the dual-color channel unit; a first output end of the dual-color channel unit is connected to a first light source control end of the dual-color light source unit; and a second output end of the dual-color channel unit is connected to a second light source control end of the dual-color light source unit.

As can be seen from the above description, by using the control unit and the dual-color channel unit to form the control processor, the control unit controls, upon receiving the dip switch signal or the wall switch signal, the first output end and the second output end of the dual-color channel unit to output different control signals to the first light source control end and the second light source control end of the dual-color light source unit, thereby achieving the switching of the color temperature of the dual-color light source unit.

Further, the dual-color channel unit includes a first metal oxide semiconductor (MOS) transistor and a second MOS transistor; the control unit includes a first pulse output end and a second pulse output end; a drain of the first MOS transistor is connected to the first light source control end of the dual-color light source unit, and a gate of the first MOS transistor is connected to the first pulse output end; a drain of the second MOS transistor is connected to the second light source control end of the dual-color light source unit, and a gate of the second MOS transistor is connected to the second pulse output end; and a source of the first MOS transistor and a source of the second MOS transistor are both connected to a ground end of the control unit.

As can be seen from the above description, by using the first MOS transistor and the second MOS transistor to form the dual-color channel unit, the control unit controls the current to the first light source and the second light source in the dual-color light source unit by outputting different pulse signals to the gates of the first MOS transistor and the second MOS transistor and controlling the duty ratio of the conduction of the first MOS transistor and the second MOS transistor, thereby achieving color temperature adjustment.

Further, the control processor further includes a power supply unit, where an input end of the power supply unit is configured to connect to a power source; and an output end of the power supply unit is connected to a power supply end of the control unit.

As can be seen from the above description, by providing the power supply unit to supply a stable voltage to the control processor, the control unit operates stably.

Further, the power supply unit includes a first resistor, a second resistor and a first zener diode; one end of the first resistor is configured to connect to the power source; the other end of the first resistor is connected to one end of the second resistor; the other end of the second resistor is connected to a cathode of the first zener diode and the power supply end of the control unit, respectively; and an anode of the first zener diode is connected to a ground end of the control unit.

As can be seen from the above description, by using the first resistor, the second resistor and the first zener diode to form the power supply unit, the voltage, after divided by the first resistor and the second resistor and stabilized by the first zener diode, from the power supply is input into the control unit, thereby ensuring more stable operation of the control processor.

Further, the dip switch processor includes a dip switch unit, a third resistor, a fourth resistor and a fifth resistor; the first input end of the control processor includes a first sub-input end, a second sub-input end and a third sub-input end; a first output end of the dip switch unit is connected to one end of the third resistor and the first sub-input end; a second output end of the dip switch unit is connected to one end of the fourth resistor and the second sub-input end; a third output end of the dip switch unit is connected to one end of the fifth resistor and the third sub-input end; the other end of the third resistor, the other end of the fourth resistor and the other end of the fifth resistor are all configured to connect to the power source; and the dip switch unit is configured to output different signals at high and low levels by being electrically connected to the third resistor, the fourth resistor and the fifth resistor.

As can be seen from the above description, by electrically connecting the output end of the dip switch unit to one end of the third resistor, one end of the fourth resistor and one end of the fifth resistor, respectively, and also to the corresponding input end of the control processor, the control processor obtains different signals at high and low levels depending on different positions of the dip switch. The control unit determines and outputs different control signals, thereby achieving color temperature adjustment.

Further, the wall switch processor includes a sixth resistor, a seventh resistor and a second zener diode, where one end of the sixth resistor is configured to connect to the power source; the other end of the sixth resistor is connected to one end of the seventh resistor, a cathode of the second zener diode and the second input end of the control processor, respectively, and is configured to detect the wall switch signal according to the operation of the external wall switch; and the other end of the seventh resistor and an anode of the second zener diode are both connected to a ground end of the control processor.

As can be seen from the above description, by arranging the sixth resistor, the seventh resistor and the second zener diode, a power-off signal and a power-on signal from the power source can be effectively collected. This allows to determine whether the user has performed a wall switch action or not, detect the wall switch signal according to the wall switch action, and outputs the corresponding pulse signal based on the wall switch signal to achieve the switching the color temperature.

Further, the LED lamp further includes a dimming constant current processor, where an input end of the dimming constant current processor is configured to connect to the power source; and an output end of the dimming constant current processor is connected to the input end of the power supply unit and an input end of the dual-color light source unit.

As can be seen from the above description, by connecting the dimming constant current processor to the power supply, the input power source can be converted into stable voltage and current to be supplied to the subsequent processors and units, thereby improving the overall operation stability of the circuit.

Further, the dimming constant current processor includes a dimming constant current unit, an eighth resistor and a ninth resistor, where an input end of the dimming constant current unit is configured to connect to an anode of the power source; one end of the eighth resistor and one end of the ninth resistor are connected to a power control end of the dimming constant current unit, respectively; and the other end of the eighth resistor and the other end of the ninth resistor are both configured to connect to a cathode of the power source.

As can be seen from the above description, by arranging the dimming constant current unit, the eighth resistor and the ninth resistor, the dimming constant current unit plays a role in stabilizing the current, while the eighth resistor and the ninth resistor are configured to set the output power of the dimming constant current unit, thereby ensuring that the dimming constant current unit operates under the appropriate power.

Further, the LED lamp further includes a rectifier unit, where an input end of the rectifier unit is configured to connect to the power source; and an output end of the rectifier unit is connected to the input end of the dimming constant current processor.

As can be seen from the above description, by arranging the rectifier unit, the input AC power source is converted into a DC power source, providing DC current to the subsequent processors and units.

A control method for an LED lamp with multi-color temperature switching includes:
acquiring, upon receiving a power-on signal and determining a change in position information of a dip switch processor, corresponding color adjustment information according to the position information, and lighting up a light source of a dual-color light source unit according to the color adjustment information; and
recording, when a wall switch processor triggers a color adjustment mode, target color adjustment information corresponding to a target color temperature, and lighting up the dual-color light source unit according to the target color adjustment information.

As can be seen from the above description, the beneficial effects of the present disclosure are as follows: after the LED lamp is powered on, whether the position information of the dip switch processor is changed or not is determined. When the position information is changed, the corresponding color adjustment information is acquired according to the position information, and the light source of the dual-color light source unit is lit up according to the color adjustment information, allowing the dip switch to control the color temperature of the LED lamp. When the wall switch processor triggers the color adjustment mode, the dual-color light source unit is lit up according to the target color adjustment information corresponding to the target color temperature, allowing the wall switch to control the color temperature of the LED lamp.

Further, the determining the change in the position information of the dip switch processor includes:
acquiring original position information before power-on and new position information after power-on;
determining that the position information is changed if the new position information is different from the original position information.

As can be seen from the above description, by acquiring and comparing the original position information before power-on and the new position information after power-on, the change in the position information is determined.

Further, the dip switch processor includes a detection end.

The determining the change in the position information of the dip switch processor includes:
determining that the position information is changed if a position of the detection end is changed.

As can be seen from the above description, by regarding the position of the detection end as the position information and determining whether the position of the detection end is changed or not, the change in the position information is determined.

Further, the detection end includes a first detection pin, a second detection pin and a third detection pin.

The determining the change in the position information of the dip switch processor includes:

determining that the position information is changed if at least one of the levels of the first detection pin, the second detection pin and the third detection pin is changed.

As can be seen from the above description, by using the first detection pin, the second detection pin and the third detection pin to form the detection end and combining different levels of the first detection pin, the second detection pin and the third detection pin to form different position information, a one-to-one correspondence with different positions on the dip switch is achieved.

Further, the acquiring the corresponding color adjustment information according to the position information includes:
acquiring the color adjustment information according to the levels of the first detection pin, the second detection pin and the third detection pin.

As can be seen from the above description, the color adjustment information is acquired according to the levels of the first detection pin, the second detection pin and the third detection pin. In other words, different combinations of the levels of the detection pins correspond to different color adjustment information, thereby achieving the switching of the color temperature of the LED lamp according to the different combinations of the levels of the detection pins.

Further, the wall switch processor triggering the color adjustment mode includes:
triggering the color adjustment mode when the wall switch processor receives a preset number of wall switch signals within a preset time period.

As can be seen from the above description, using the reception of a preset number of wall switch signals by the wall switch processor within a preset time period as a criterion for triggering the color adjustment mode allows for effective triggering of the color adjustment mode while preventing accidental triggering due to unintended operation of the wall switch.

Further, the color adjustment mode includes:
controlling the dual-color light source unit to cyclically switch between at least two different color temperatures.

As can be seen from the above description, by controlling the dual-color light source unit to cyclically switch between the at least two different color temperatures in the color adjustment mode, different color temperature options are provided for the user by continuously cycling among different color temperatures.

Further, the controlling the dual-color light source unit to cyclically switch between the at least two different color temperatures includes:
outputting sequentially and cyclically at least two different color adjustment information to the dual-color light source unit.

As can be seen from the above description, by cyclically outputting different color adjustment information, cyclical switching among different color temperatures is achieved based on the output of different color adjustment information.

Further, the recording the target color adjustment information corresponding to the target color temperature includes:
regarding the color temperature upon power-off as the target color temperature, and recording the target color adjustment information corresponding to the target color temperature.

As can be seen from the above description, by regarding the color temperature upon power-off as the target color temperature, the power-off operation is performed through the wall switch when cyclical switching reaches the target color temperature. This allows the target color adjustment information corresponding to the target color temperature to be recorded, and the LED lamp to be lit up according to the target color adjustment information when the power is turned on again.

Further, the color adjustment information includes a first pulse width modulation (PWM) and a second PWM; and
the proportions of the first PWM and the second PWM are different in different color adjustment information.

As can be seen from the above description, by regarding the first PWM and the second PWM as the color adjustment information, different color adjustment information is output by adjusting the proportion of the first PWM and the second PWM, thereby achieving the output of different color temperatures.

The LED lamp with multi-color temperature switching provided by the present disclosure is applied to lighting products, enabling the switching of color temperature through the dip switch on the LED lamp, and the switching of the color temperature of the LED lamp through the wall switch, which is to be illustrated by specific implementations as follows.

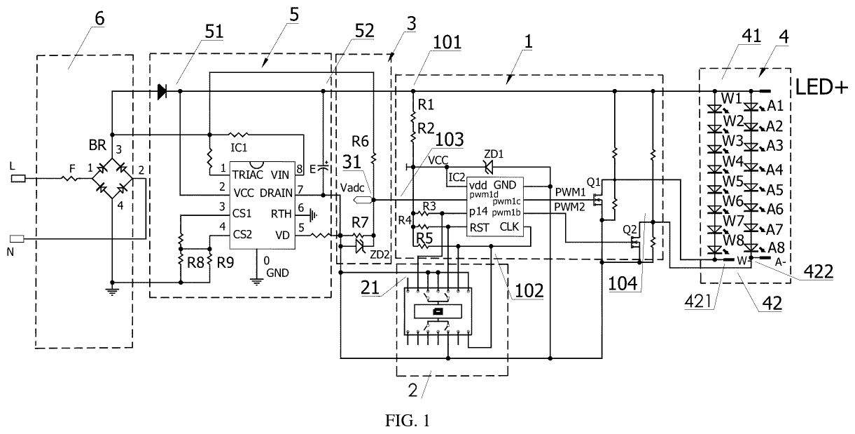

In some embodiments, referring to FIG. 1, an LED lamp with multi-color temperature switching includes a control processor 1, a dip switch processor 2, a wall switch processor 3, a dual-color light source unit 4, a dimming constant current processor 5 and a rectifier unit 6. An input end (pin 1 and pin 2) of the rectifier unit 6 is configured to connect to a power source (L&N), rectify AC current into DC current, and supply power to the subsequent processors and units of the circuit. An output end (pin 3 and pin 4) of the rectifier unit 6 is connected to an input end 51 of the dimming constant current processor 5, and an output end 52 of the dimming constant current processor 5 is connected to a power source input end 101 of the control processor 1 and an input end 41 of the dual-color light source unit 4. A first input end 102 of the control processor 1 is connected to an output end 21 of the dip switch processor 2 that receives a dip switch signal, and a second input end 103 of the control processor 1 is connected to an output end 31 of the wall switch processor 3 that receives a wall switch signal. An output end 104 of the control processor 1 is connected to a control end 42 of the dual-color light source unit 4. The control processor 1 is configured to adjust a current output to the dual-color light source unit 4 according to the dip switch signal or the wall switch signal. In some embodiments, the dual-color light source unit 4 includes a first light source (W1-W8) and a second light source (A1-A8), for example, the first light source is 2700K, and the second light source is 5000K.

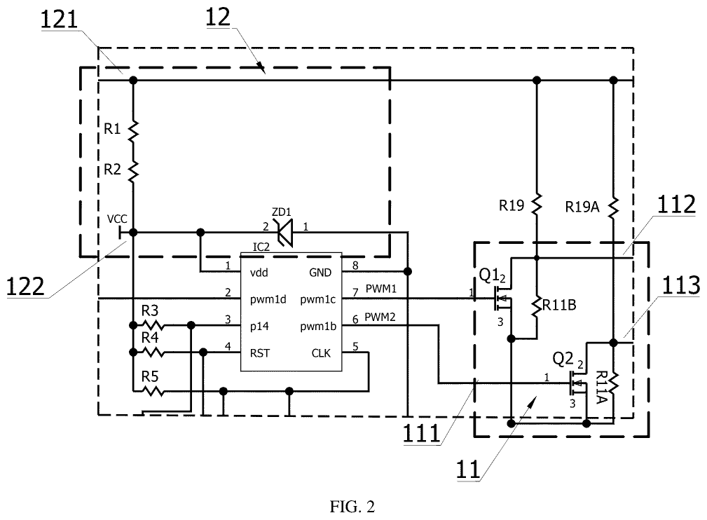

Referring to FIG. 2, the control processor 1 includes a control unit IC2, a dual-color channel unit 11 and a power supply unit 12. A first input end (pin 3, pin 4 and pin 5) of the control unit IC2 is connected to the output end 21 of the dip switch processor 2, a second input end (pin 2) of the control unit IC2 is connected to the output end 31 of the wall switch processor 3, and an output end (pin 6 and pin 7) of the control unit IC2 is connected to an input end 111 of the dual-color channel unit 11. A first output end 112 of the dual-color channel unit 11 is connected to a first light source control end 421 of the dual-color light source unit 4, and a second output end 113 of the dual-color channel unit 11 is connected to a second light source control end 422 of the dual-color light source unit 4. An input end 121 of the power supply unit 12 is connected to a power supply, and an output end 122 of the power supply unit 12 is connected to a power supply end (pin 1) of the control unit IC2.

The dual-color channel unit 11 includes a first MOS transistor Q1 and a second MOS transistor Q2. The control unit IC2 includes a first pulse output end (pwm1c) and a second pulse output end (pwm1b). A drain of the first MOS transistor Q1 is connected to the first light source control end 421 of the dual-color light source unit 4, which is a cathode of the light emitting diode; and a gate of the first MOS transistor Q1 is connected to the first pulse output end. A drain of the second MOS transistor Q2 is connected to the second light source control end 422 of the dual-color light source unit 4, which is a cathode of the light emitting diode; and a gate of the second MOS transistor Q2 is connected to the second pulse output end. A source of the first MOS transistor Q1 and a source of the second MOS transistor Q2 are both connected to a ground end of the control unit IC2.

The power supply unit 12 includes a first resistor R1, a second resistor R2 and a first zener diode ZD1. One end of the first resistor R1 is connected to the power supply, the other end of the first resistor R1 is connected to one end of the second resistor R2, the other end of the second resistor R2 is connected to a cathode of the first zener diode ZD1 and the power supply end of the control unit IC2, respectively, and an anode of the first zener diode ZD1 is connected to the ground end (GND) of the control unit IC2. In some embodiments, a stable power supply voltage of 4.7V is obtained through the first resistor R1, the second resistor R2 and the first zener diode ZD1. Moreover, a linear power supply solution is adopted, which helps reduce the cost.

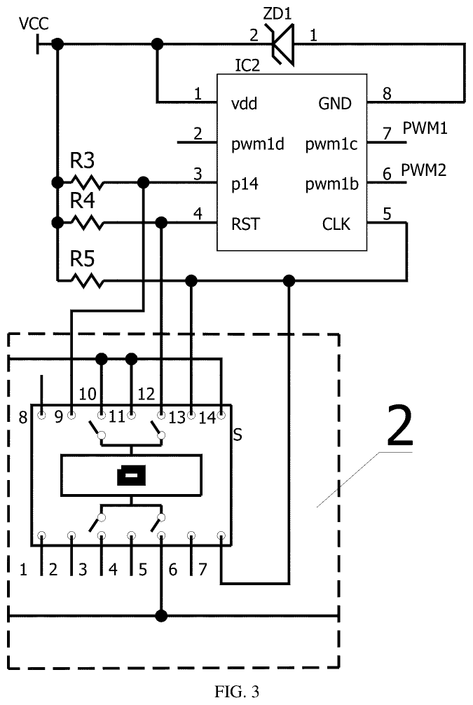

Referring to FIG. 3, the dip switch processor 2 includes a dip switch unit S, a third resistor R3, a fourth resistor R4 and a fifth resistor R5. The first input end of the control processor 1 includes a first sub-input end (pin 3), a second sub-input end (pin 4) and a third sub-input end (pin 5). A first output end (pin 10) of the dip switch unit S is connected to one end of the third resistor R3 and the first sub-input end, a second output end (pin 12) of the dip switch unit S is connected to one end of the fourth resistor R4 and the second sub-input end, and a third output end (pin 13) of the dip switch unit S is connected to one end of the fifth resistor R5 and the third sub-input end. The other ends of the third resistor R3, the fourth resistor R4 and the fifth resistor R5 are all configured to connect to the power source. The dip switch unit S is configured to output different signals at high and low levels by being electrically connected to the third resistor R3, the fourth resistor R4 and the fifth resistor R5.

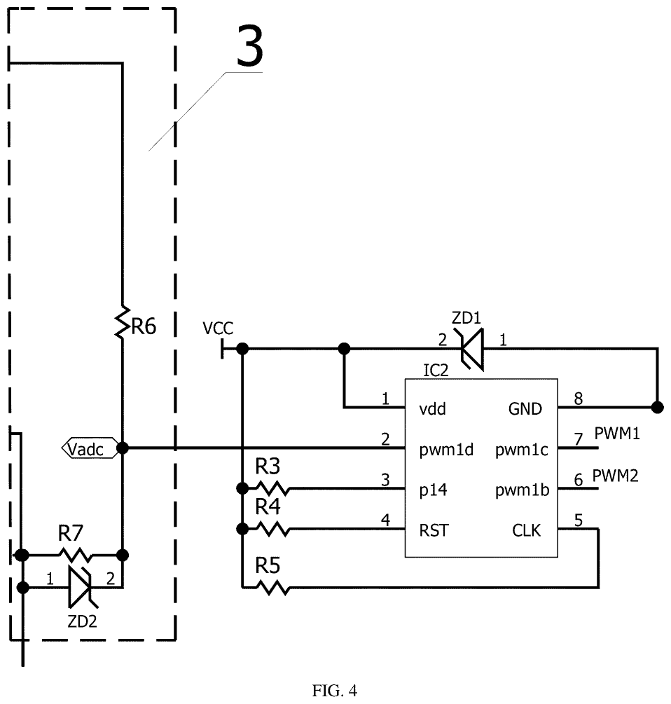

Referring to FIG. 4, the wall switch processor 3 includes a sixth resistor R6, a seventh resistor R7 and a second zener diode ZD2. One end of the sixth resistor R6 is configured to connect to the power source, and the other end of the sixth resistor R6 is connected to one end of the seventh resistor R7, a cathode of the second zener diode ZD2 and the second input end of the control processor 1, respectively, and is configured to detect the wall switch signal according to the operation of the external wall switch. The other end of the seventh resistor R7 and an anode of the second zener diode ZD2 are both connected to the ground end of the control processor 1. The sixth resistor R6, the seventh resistor R7 and the second zener diode ZD2 are configured to detect whether a bus voltage after a rectifier bridge drops or not, thereby determining whether the user performs a wall switch action or not.

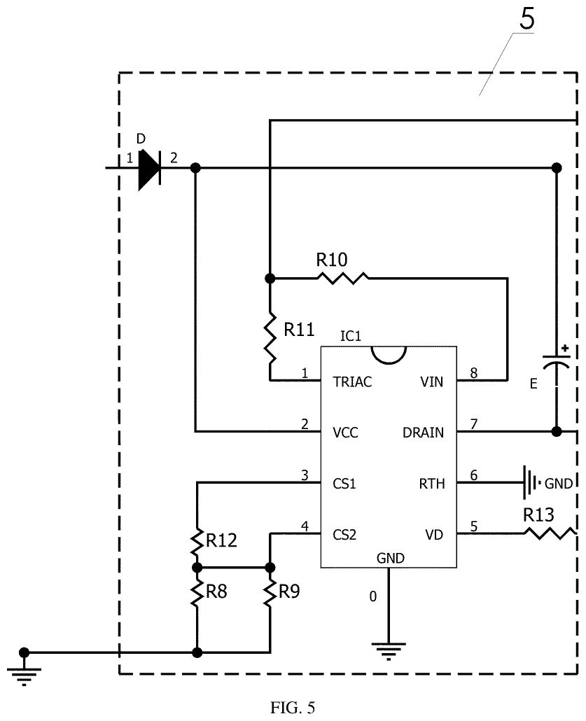

Referring to FIG. 5, the dimming constant current processor 5 includes a dimming constant current unit IC1, an eighth resistor R8 and a ninth resistor R9. An input end (VCC) of the dimming constant current unit IC1 is configured to connect to an anode of the power supply. One end of the eighth resistor R8 and one end of the ninth resistor R9 are connected to a power control end (CS2) of the dimming constant current unit IC1, respectively, and the other end of the eighth resistor R8 and the other end of the ninth resistor R9 are both configured to connect to a cathode of the power source. By setting the resistance values of the eighth resistor R8 and the ninth resistor R9, the controllable silicon dimming function of the entire lamp and the maximum power setting for the entire lamp are achieved.

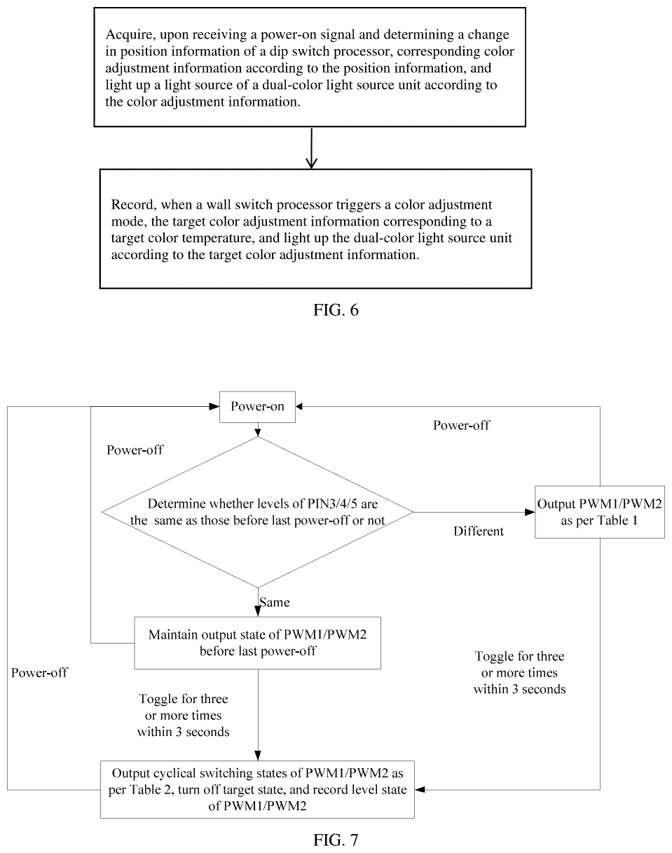

Referring to FIG. 6, a control method for an LED lamp with multi-color temperature switching includes:
S1: acquiring, upon receiving a power-on signal and determining a change in position information of a dip switch processor, corresponding color adjustment information according to the position information, and lighting up a light source of a dual-color light source unit according to the color adjustment information. Whether the position information is changed or not is determined by the following ways:
acquiring original position information before power-on and new position information after power-on; determining that the position information is changed if the new position information is different from the original position information. In some embodiments, the detection end of the dip switch processor serves as the position information, indicating that the position information is changed when the position of the detection end is changed. In a further embodiment, the detection end includes a first detection pin, a second detection pin and a third detection pin. The levels of the first detection pin, the second detection pin and the third detection pin jointly serve as the position information, indicating that the position information is changed when at least one of the levels of the first detection pin, the second detection pin and the third detection pin is changed. During acquiring the color adjustment information, the color adjustment information is acquired according to the levels of the first detection pin, the second detection pin and the third detection pin. And
S2: recording, when a wall switch processor triggers a color adjustment mode, target color adjustment information corresponding to a target color temperature, and lighting up the dual-color light source unit according to the target color adjustment information. In some embodiments, whether the color adjustment mode is triggered or not is determined by the following ways: triggering the color adjustment mode when the wall switch processor receives a preset number of wall switch signals within a preset time period. For example, it is set as: triggering the color adjustment mode when the wall switch is toggled for three or more times within 3 seconds, or five or more times within 5 seconds, etc., thereby enabling the color temperature selection function.

After the color adjustment mode is triggered, the dual-color light source unit is controlled to cyclically switch between at least two different color temperatures. The color temperature upon power-off is set as the target color temperature, and the target color adjustment information corresponding to the target color temperature is recorded. For example, the lamp enters a state of cyclically switching the color temperature, such as 2700K→3000K→3500K→4000K→5000K→2700K→ . . . , where each of the color temperatures lasts for 2 seconds. When the target color temperature such as 3500K is cyclically switched, the wall switch is turned off, and 3500K is recorded. The lamp continues to be on at 3500K upon being powered on again. Unless the wall switch is operated again, the lamp will continue to operate at 3500K, thereby achieving an AUTO function, which is a function of automatically and cyclically the color temperatures with the power-off selection of the color temperatures.

The cyclical switching of the color temperatures is implemented by the following ways: outputting sequentially and cyclically at least two pieces of different color adjustment information to the dual-color light source unit, where the color adjustment information includes a first PWM and a second PWM, and the proportions of the first PWM and the second PWM are different in different color adjustment information. Therefore, the color temperature is switched by outputting different first PWM and second PWM.

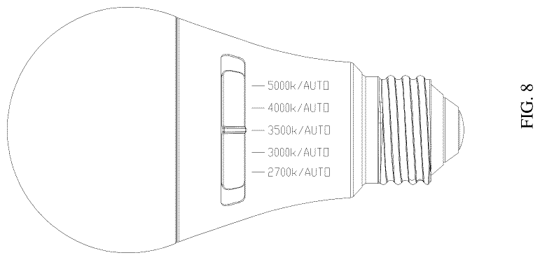

In some embodiments, the dip switch unit S employs a switch S including two or more positions, as shown in FIG. 3 and FIG. 8. For example, a 5-position switch is employed. The pins PIN3/4/5 (the first detection pin/the second detection pin/the third detection pin) of the control unit IC2 are pulled up to VCC through the third resistor R3, the fourth resistor R4 and the fifth resistor R5 respectively. The levels of the three pins PIN3/4/5 are changed by toggling the switch. Based on the information in the Table 1 as below, the control unit IC2 outputs different PWM1/PWM2 signals to the gates of the first MOS transistor Q1 and the second MOS transistor Q2 in the dual-color channel unit 11. This controls the duty ratio of the conduction of both MOS transistors, thereby regulating the current of the first light source and the second light source in the dual-color light source unit 4, and further achieving color temperature adjustment. For example, by toggling the switch on the lamp from left to right, the setting of the first position being 2700K, the second position being 3000K, the third position being 3500K, the fourth position being 4000K, and the fifth position being 5000 k can be achieved. If the preferred target color temperature of the user is 3500K, the user can simply set the switch to the third position of 3500K before installing the lamp. Once powered on, the lamp will automatically light up at the corresponding target color temperature of 3500K. In other words, the lamp will light up at the selected color temperature based on the toggled position prior to power-on. This meets the needs of the user for quickly and directly selecting a desired color temperature by toggling a hardware dip switch.

TABLE 1
Table for States of Dip Switch Unit S

| | Pin3/4/5 level | | | | |
|---|---|---|---|---|---|
| | 1st | 2nd | 3rd | 4th | 5th |
| | position: | position: | position: | position: | position: |
| | high/high/ | low/high/ | high/low/ | high/high/ | high/low/ |
| | high | high | high | low | low |
| PWM1 | 100% | 87% | 67% | 40% | 0% |
| PWM2 | 0% | 13% | 33% | 60% | 100% |

For example, after the lamp is installed and powered the pin PIN2 of the control unit IC2 will detect the power-on and power-off signals by operating the wall switch. In this case, the control unit IC2 outputs PWM1/PWM2 signals according to Table 2 as below, causing the lamp to enter a state of cyclically switching the color temperatures, such as 2700K→3000K→3500K→4000K→5000K→2700K→ . . . , where each of the color temperatures lasts for 2 seconds. When the wall switch is operated, the color adjustment mode is triggered through programming and configuration of the control unit IC2. For example, the color temperature selection mode is activated by toggling the wall switch for three or more times within 3 seconds, or five or more times within 5 seconds. This meets the needs of the user for convenient and flexible color temperature switching while avoiding accident switching. Meanwhile, operating the wall switch does not affect the levels of the pins PIN3/4/5 of the control unit IC2. In other words, the levels of the three pins PIN3/4/5 of the control unit IC2 can only be changed by the dip switch. If the control is later switched back to the dip switch, the lamp will automatically exit the color temperature defined by the AUTO mode, and the color temperature returns to the corresponding color temperature position of the dip switch.

TABLE 2
Table for PWM1/PWM2 signal output by control unit IC2

| | 2700 K | 3000 K | 3500 K | 4000 K | 5000 K |
|---|---|---|---|---|---|
| PWM1 | 100% | 87% | 67% | 40% | 0% |
| PWM2 | 0% | 13% | 33% | 60% | 100% |

Referring to FIG. 7, a software program is provided in the control unit IC2 to handle the priority between the AUTO mode and the toggling of the dip switch. After the entire lamp is powered on, whether the states of the levels of the pins PIN3/4/5 of the control unit IC2 are the same as those before the last power-off or not is first determined. (1) If the states are the same, it indicates that the dip switch has not been toggled, in this case, the PWM1/PWM2 state before the last power-off is maintained, that is, the color temperature before the power-off remains unchanged. (2) If the states are different, it indicates that the dip switch has been toggled, that is, the user wants to change the color temperature using the dip switch, in this case, the PWM1/PWM2 state is output according to the toggled position, as specified in Table 1.

During operating normally, the lamp will enter a state of cyclically switching the color temperature defined in Table 2 if the wall switch is toggled for three or more times within 3 seconds. When the user turns off the lamp in a certain state, the control unit IC2 records the state (including the states of high and low levels of the pins PIN3/4/5). On the next power-on, whether the states of the levels of the pins PIN3/4/5 are the same as those before the last power-off or not is determined again. Based on the determination, the lamp proceeds with one of the actions (1) and (2) as described above, and the program operates according to this logic. This ensures that the final color temperature is always determined by the most recent action of the user, allowing the color temperature to follow the preference of the user accurately and flexibly, thereby making the experience both intelligent and convenient.

The above as described is only embodiments of the present disclosure, and does not limit the patent scope of the present disclosure. Any equivalent modifications made based on the contents of the specification and accompanying drawings of the present disclosure, direct or indirect applications in related technical fields, are equally embraced in the patent protection scope of the present disclosure.

What is claimed is:

1. A light emitting diode (LED) lamp with multi-color temperature switching, comprising:
a control processor, a first input end of the control processor being connected to an output end of a dip switch processor which receives a dip switch signal; a second input end of the control processor being connected to an output end of a wall switch processor which receives a wall switch signal; and
an output end of the control processor being connected to a control end of a dual-color light source unit;
wherein the control processor adjusts a current output to the dual-color light source unit according to the dip switch signal or the wall switch signal.

2. The LED lamp with multi-color temperature switching according to claim 1, wherein the control processor comprises a control unit and a dual-color channel unit;
a first input end of the control unit is connected to the output end of the dip switch processor;
a second input end of the control unit is connected to the output end of the wall switch processor;
an output end of the control unit is connected to an input end of the dual-color channel unit;
a first output end of the dual-color channel unit is connected to a first light source control end of the dual-color light source unit; and
a second output end of the dual-color channel unit is connected to a second light source control end of the dual-color light source unit.

3. The LED lamp with multi-color temperature switching according to claim 2, wherein the dual-color channel unit comprises a first metal oxide semiconductor (MOS) transistor and a second MOS transistor; the control unit comprises a first pulse output end and a second pulse output end;
a drain of the first MOS transistor is connected to the first light source control end of the dual-color light source unit, and a gate of the first MOS transistor is connected to the first pulse output end;
a drain of the second MOS transistor is connected to the second light source control end of the dual-color light source unit, and a gate of the second MOS transistor is connected to the second pulse output end; and
a source of the first MOS transistor and a source of the second MOS transistor are both connected to a ground end of the control unit.

4. The LED lamp with multi-color temperature switching according to claim 2, wherein the control processor further comprises a power supply unit;
an input end of the power supply unit is configured to connect to a power source; and
an output end of the power supply unit is connected to a power supply end of the control unit.

5. The LED lamp with multi-color temperature switching according to claim 4, wherein the power supply unit comprises a first resistor, a second resistor and a first zener diode;
one end of the first resistor is configured to connect to the power source;
the other end of the first resistor is connected to one end of the second resistor;
the other end of the second resistor is connected to a cathode of the first zener diode and the power supply end of the control unit, respectively; and
an anode of the first zener diode is connected to a ground end of the control unit.

6. The LED lamp with multi-color temperature switching according to claim 2, wherein the dip switch processor comprises a dip switch unit, a third resistor, a fourth resistor and a fifth resistor;
the first input end of the control processor comprises a first sub-input end, a second sub-input end and a third sub-input end;
a first output end of the dip switch unit is connected to one end of the third resistor and the first sub-input end;
a second output end of the dip switch unit is connected to one end of the fourth resistor and the second sub-input end;
a third output end of the dip switch unit is connected to one end of the fifth resistor and the third sub-input end;
the other end of the third resistor, the other end of the fourth resistor and the other end of the fifth resistor are all configured to connect to a power supply end of the control unit; and
the dip switch unit is configured to output different signals at high and low levels by being electrically connected to the third resistor, the fourth resistor and the fifth resistor.

7. The LED lamp with multi-color temperature switching according to claim 1, wherein the wall switch processor comprises a sixth resistor, a seventh resistor and a second zener diode;
one end of the sixth resistor is configured to connect to a power source;
the other end of the sixth resistor is connected to one end of the seventh resistor, a cathode of the second zener diode and the second input end of the control processor, respectively, and is configured to detect the wall switch signal according to the operation of the external wall switch; and
the other end of the seventh resistor and an anode of the second zener diode are both connected to a ground end of the control processor.

8. The LED lamp with multi-color temperature switching according to claim 4, further comprising a dimming constant current processor;
an input end of the dimming constant current processor is configured to connect to the power source; and
an output end of the dimming constant current processor is connected to the input end of the power supply unit and an input end of the dual-color light source unit.

9. The LED lamp with multi-color temperature switching according to claim 8, wherein the dimming constant current processor comprises a dimming constant current unit, an eighth resistor and a ninth resistor;
an input end of the dimming constant current unit is configured to connect to an anode of the power source;
one end of the eighth resistor and one end of the ninth resistor are connected to a power control end of the dimming constant current unit, respectively; and
the other end of the eighth resistor and the other end of the ninth resistor are both configured to connect to a cathode of the power source.

10. The LED lamp with multi-color temperature switching according to claim 8, further comprising a rectifier unit; wherein
an input end of the rectifier unit is configured to connect to the power source; and
an output end of the rectifier unit is connected to the input end of the dimming constant current processor.
